(19) United States
(12) Patent Application Publication
(10) Pub. No.: US 2014/0036771 A1
(43) Pub. Date: Feb. 6, 2014

(54) Networked Video Bridge Device

(71) Applicant: EMERSON ELECTRIC CO., St. Louis, MO (US)

(72) Inventors: Jay Gatz, O'Fallon, MO (US); Paul W. Gress, Bay Village, OH (US); Justin Daw, North Ridgeville, OH (US)

(73) Assignee: EMERSON ELECTRIC CO., St. Louis, MO (US)

(21) Appl. No.: 13/837,708

(22) Filed: Mar. 15, 2013

Related U.S. Application Data
(60) Provisional application No. 61/678,093, filed on Jul. 31, 2012.
(60) Provisional application No. 61/677,920, filed on Jul. 31, 2012.

(51) Int. Cl. H04W 88/16

(52) U.S. Cl. CPC H04W 88/16
USPC 370/328

(57) ABSTRACT

A networked video bridge device includes a data input module that receives at least one raw image data stream from a plurality of data sources. The device further includes a storage module that records the raw image data and temporarily stores the raw image data. A display screen displays the raw image data. The device also includes a user interface module that receives user input data from a user of the networked video bridge device. The device also includes a control module that selectively augments the raw image data based on the user input data. The control module also communicates the augmented image data to a remote image data storage device.

### CROSS-REFERENCE TO RELATED APPLICATIONS

This application claims the benefit of U.S. Provisional Application No. 61/678,093, filed on Jul. 31, 2012 and U.S. Provisional Application No. 61/677,920, filed on Jul. 31, 2012. The entire disclosure of each of the above applications is incorporated herein by reference.

### FIELD

The present disclosure generally relates to a system for capturing, augmenting, transmitting, displaying and storing image data. More particularly, the present disclosure relates to a networked video bridge device for use in such system.

### BACKGROUND

Many skilled trades and service contractors, such as plumbers, electricians, HVAC professionals and home inspectors, perform jobsite evaluations diagnostics, and inspections for a variety of purposes such as searching for potential problems, diagnosing problems and checking or verifying a technician's work at the jobsite, for example. Technicians often document their findings with notes, voice annotations, photographs and/or videos taken at the jobsite. Such documentation can be useful for diagnosis, collaborative problem solving, reporting inspection results to clients, cost estimating and/or preparing for future service or inspections at a particular jobsite.

In some circumstances, the technician capturing the notes, photographs, videos or other data at the jobsite may benefit from the ability to collect, organize and transmit this data to remotely located networks, computers, or other users. Accordingly, a system for capturing, augmenting, and transmitting such data is desired.

This section provides background information related to the present disclosure which is not necessarily prior art.

### SUMMARY

A networked video bridge device includes a data input module that receives at least one raw image data stream from a plurality of data sources. The device further includes a storage module that records the raw image data and temporarily stores the raw image data. A display screen displays the raw image data. The device also includes a user interface module that receives user input data from a user of the networked video bridge device. The device also includes a control module that selectively augments the raw image data based on the user input data. The control module also communicates the augmented image data to a remote image data storage device.

In other features, a method includes receiving at least one raw image data stream from a plurality of data sources. The method also includes recording the raw image data and temporarily storing the raw image data. The method further includes displaying the raw image data. The method also includes receiving user input data from a user of a networked video bridge device and selectively augmenting the raw image data based on the user input data. The method also includes communicating the augmented image data to a remote image data storage device.

Further areas of applicability of the present disclosure will become apparent from the detailed description provided hereinafter. It should be understood that the detailed description and specific examples are intended for purposes of illustration only and are not intended to limit the scope of the disclosure.

### DRAWINGS

The drawings described herein are for illustrative purposes only of selected embodiments and not all possible implementations, and are not intended to limit the scope of the present disclosure.

FIG. 1 is a schematic block diagram showing a system for capturing, augmenting and transmitting image data incorporating the networked video bridge device of the present disclosure;

FIG. 2 shows an exemplary configuration for the networked video bridge device of the present disclosure;

FIG. 3 is a schematic block diagram of the networked video bridge device of FIG. 2;

FIG. 4 shows an alternative schematic block diagram for the networked video bridge device of the present disclosure; and

FIG. 5 is a flow diagram illustrating an image data capture method according to the principles of the present disclosure.

### DETAILED DESCRIPTION

Example embodiments will now be described more fully with reference to the accompanying drawings.

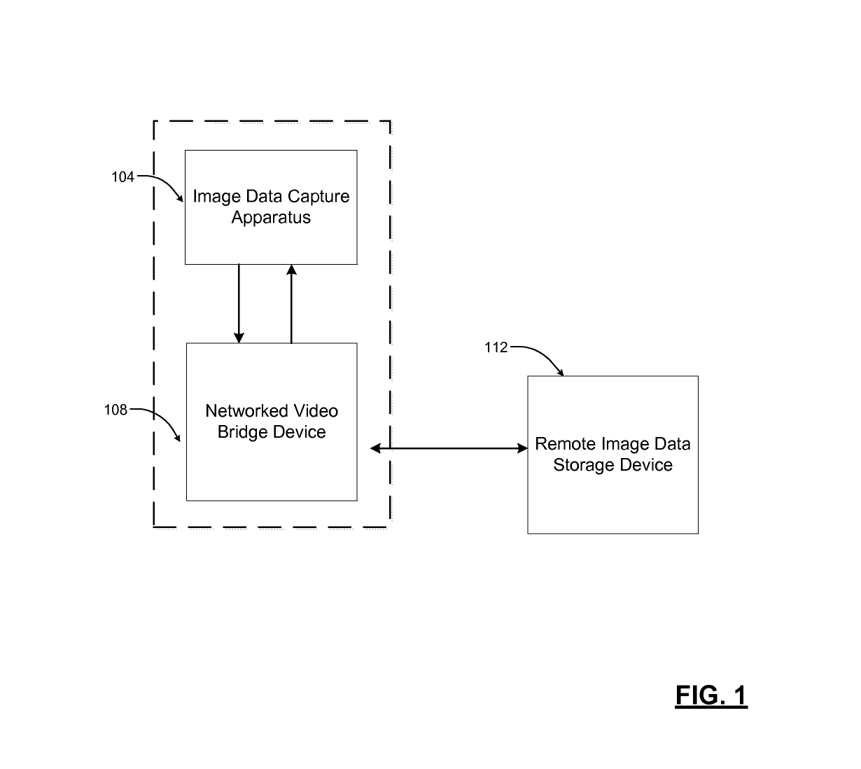

Referring now to the Figures, a system for capturing, augmenting, and transmitting image data that incorporates a networked video bridge device of the present disclosure is schematically shown in FIG. 1. The system is shown to generally include an image data capture apparatus 104, a networked video bridge device 108, and a remote image data storage device 112. In general, the image data capture apparatus 104 collects raw image data, such as during inspection activities at a jobsite, for example. The raw image data is then communicated by the image data capture apparatus 104 to the networked video bridge device 108 in real time.

At the networked video bridge device 108, the raw image data is buffered or temporarily stored in a storage module within the networked video bridge device 108. Additionally, at the networked video bridge device 108, the image data may be viewed and/or augmented with supplemental data input or provided by a user. Subsequently, the networked video bridge device 108 can transmit (e.g., upload) the image data with augmentation to the remote image data storage device 112, where the image data may be subject to further use and/or manipulation. Augmentation is understood to include notes, annotations, highlighting, commentary, remarks, and the like.

Further, image data can encompass not only video and still photographic data, but also position or location data, time stamping data, customer contact data, billing data, work request data, jobsite data, diagnostic data, measurement data, and the like, all of which may be generated or supplied by or to the image data capture apparatus 104.

The image data capture apparatus 104 can comprise any of a number of inspection and/or locating devices that are well-known in the art. Exemplary image data capture devices include plumbing video inspection devices like any of several devices in the SeeSnake® line of products available from The Ridge Tool Company of Elyria, Ohio. Other exemplary image data capture devices include tight quarters video inspection devices like the SeeSnake® micro™ inspection camera from The Ridge Tool Company and underground horizontal bore inspection devices. In another embodiment, the image data capture apparatus 104 may comprise video transmitting devices such as a WiFi enabled camera, video conferencing hardware communicating via an internet connection, or Google Glass. The image data capture apparatus 104 may also comprise a data transmitting device such as a mobile hotspot. For example, the image data capture apparatus 104 may be a MiFi device coupled to a WiFi enabled camera or other suitable image capture device.

The image data capture apparatus 104 can include a charge-coupled device (CCD) camera, for example, for capturing digital images, including both still images and video (collectively, image data), in a work environment, such as during a video inspection at a jobsite. An output device, such as a communications cable having a standard video connector, provides a means for connecting to and transmitting the image data from the image data capture apparatus 104 to the networked video bridge device 108. Alternatively, the image data capture apparatus 104 can communicate the image data to the networked video bridge device 108 wirelessly, such as via Bluetooth or WiFi.

The remote image data storage device 112 can comprise a website hosted on the internet. The website can receive and store the image data that is transmitted (e.g., uploaded) from the networked video bridge device 108. In addition, the website can provide a user interface for remotely communicating with the networked video bridge device 108. In this regard, a user interface of the remote image data storage device 112 can provide commands to the networked video bridge device 108 to remotely control its function or operation, or provide instructions to a user operating the networked video bridge device 108. Moreover, the website can include software applications for enabling viewing, editing, organizing, report generation, analytics, image processing and/or other further processing the image data. Additionally, the remote image data storage device 112 may communicate with video viewing hardware, such as Google Glass.

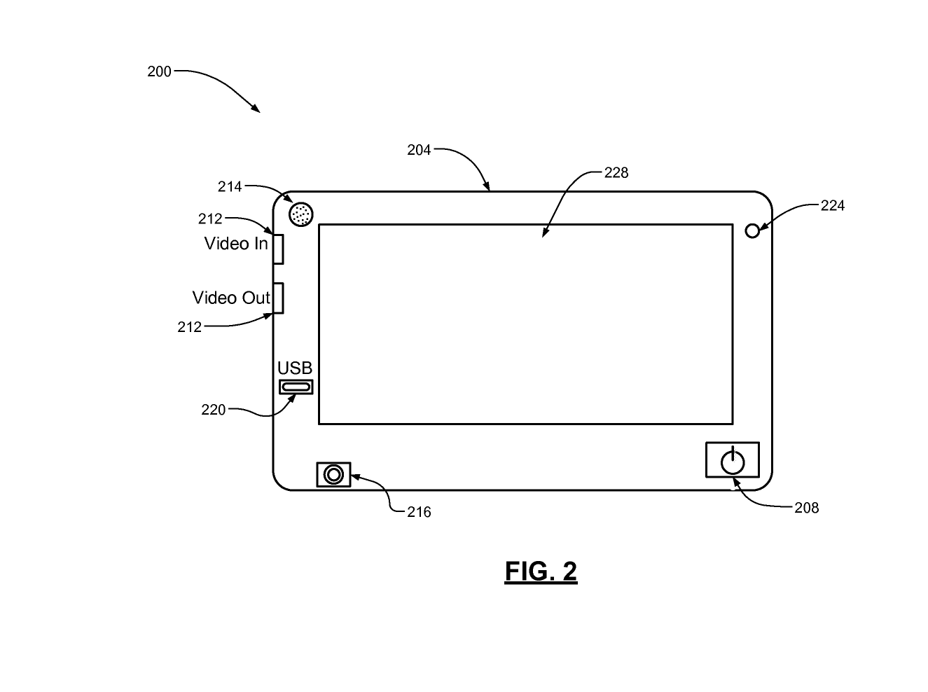

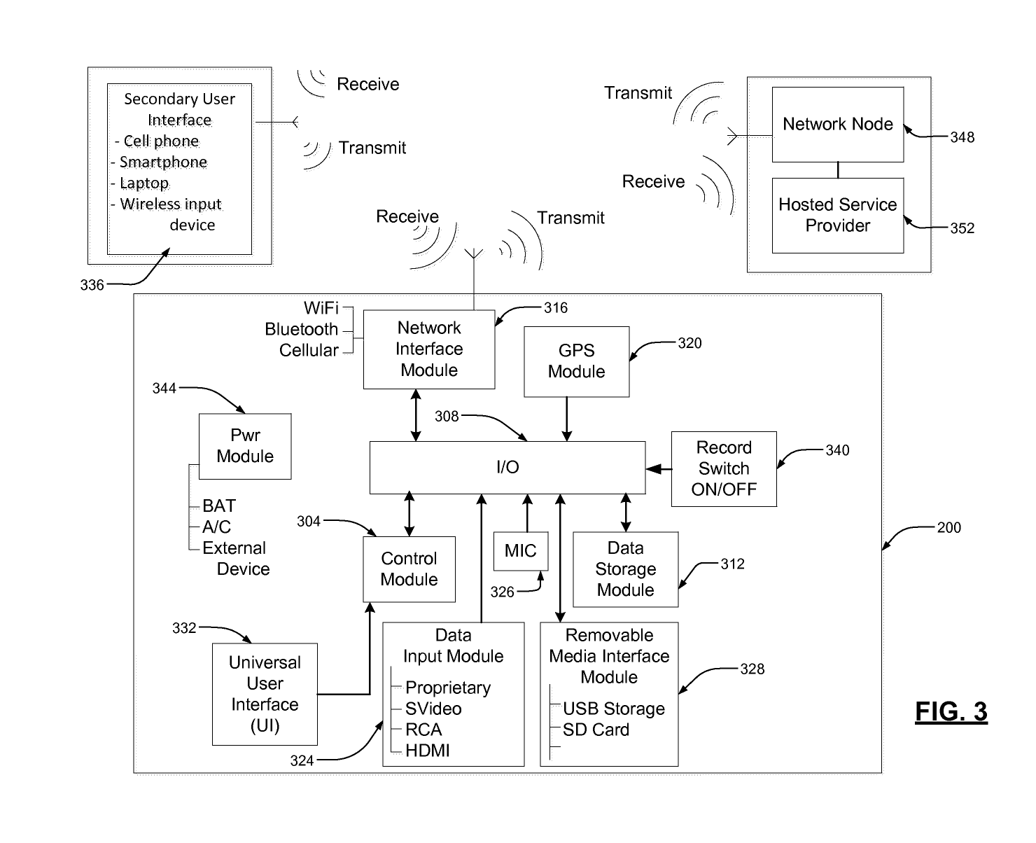

Turning now to FIGS. 2-5, several exemplary configurations of a networked video bridge device 200 of the present disclosure are shown. With particular reference to FIG. 2, an example configuration for the networked video bridge device 200 of the present disclosure is illustrated, and a schematic block diagram of the networked video bridge device 200 of FIG. 2 is shown in FIG. 3. The networked video bridge device 200 includes a housing 204 which encases the component modules of the device 200. A user accessible power switch 208 enables the user to turn ON and OFF the device 200.

Also accessible are several video input connectors 212 and an audio input connector 214 that enable connection with an output device from the image data capture apparatus 104. The image data is thereby transmitted to the networked video bridge device 200, and a user actuated switch 216 is provided for toggling the recording of the image data in the networked video bridge device 200 between ON and OFF. A USB input connection 220 is also provided, as are indicators 224 representing the status of the device 200, such as network connectivity and power, for example. The networked video bridge device 200 also includes an integrated display module 228 for viewing the image data in the networked video bridge device 200.

With particular reference to FIG. 3, a schematic block diagram of the networked video bridge device 200 of FIG. 2 is shown. The networked video bridge device 200 generally includes a control module 304 (e.g., including a central processing unit and memory) and an input/output (I/O) module 308. A data storage module 312, a network interface module 316, a global positioning system (GPS) module 320, a data input module 324, and a removable storage media interface module 328 also form component modules of the networked video bridge device 200.

The control module 304 can comprise a central processing unit (CPU), such as a microprocessor, and a memory, which may include both volatile (e.g., RAM) and non-volatile (e.g., ROM, EEPROM) memory types. The control module 304 can include an operating system that comprises a universal user interface (UI) 332 to the networked video bridge device 200. The UI 332 can establish and manage the operating features and protocols for the networked video bridge device 200. The I/O module 308 serves as a data bus across which the control module 304 can communicate with the various component modules and the component modules can communicate with each other, as required.

The data storage module 312 can include a storage device for storing and retrieving the image data provided to the networked video bridge device 200 from the image data capture apparatus 104. The storage module 312 can comprise a hard disk drive (HDD), a solid-state drive (SSD), or a hybrid drive that combines the features of both HDDs and SSDs. Optionally, storage of the image data in the networked video bridge device 200 can be controlled by the user.

For example, as the image data is being received in the networked video bridge device 200 in real time, the user can selectively toggle ON and OFF whether the image data will be stored in the data storage module 312. This selectivity allows the user to control the content of the image data that is recorded (e.g., stored in the data storage module) and minimize or eliminate extraneous or less important image data for which it is not necessary to maintain a record. This enables the user to maximize the available space in the data storage module 312.

The network interface module 316 provides network communications capabilities enabling the networked video bridge device 200 to communicate over a variety of wireless network protocols and/or standards, including IEEE 802.11 standards for implementing wireless local area network (WLAN) computer communication in the 2.4, 3.6 and 5 GHz frequency bands (e.g., WiFi), the Bluetooth standard for exchanging data over short distances (using short-wavelength radio transmissions in the ISM band from 2400-2480 MHz) from fixed and mobile devices, creating personal area networks (PANs) with high levels of security, and a variety of cellular network technology standards such as LTE (i.e., 4G LTE), UMTS/HSPA (i.e., 3G), GSM/EDGE (i.e., Edge), or CDMA. Additionally, the network interface module 316 can also enable wired network communication capabilities, such as IEEE 802.3 (e.g., Ethernet).

The GPS module 320 incorporates a GPS receiver that is operable to receive signals from the Global Positioning System space-based satellite navigation system for determining the location of the networked video bridge device 200 on Earth. The GPS module 320 may comprise a GPS navigation software program. The GPS module 320 can provide location data to coincide with, and which may augment, the image data stored in the networked video bridge device 200. In one embodiment, the GPS module 320 may provide low resolution location data to coincide with the image data stored in the networked video bridge device 200. For example, the GPS module 320 may be arranged to estimate a location of the device 200 to within a first tolerance. The first tolerance may be within three to four meters of an actual location of the device 200, for example.

In another embodiment, the GPS module 320 may provide high resolution location data to coincide with the image data stored in the networked video bridge device 200. For example, the GPS module 320 may be arranged to estimate a location of the device 200 to within a second tolerance. The second tolerance may be within one to two centimeters of an actual location of the device 200, for example.

In yet another embodiment, the networked video bridge device 200 may correlate a location provided by the GPS module 320 to a plurality of post processing data in order to estimate an actual location of the device 200. For example, the networked video bridge device 200 may obtain a location and a timestamp from the GPS module 320 corresponding to an estimated location of the device 200 at a particular time. The device 200 may correlate data received from the network interface module 316 to the location and timestamp. The data received from the network interface module 316 corresponds to cellular network metadata captured by a cellular provider contemporaneously with the timestamp. The network interface module 316 may receive the cellular network metadata after the GPS module 320 provides the location and timestamp. The networked video bridge device 200 estimates an actual location of the device 200 at the time of the timestamp based on the location, timestamp, and cellular network metadata.

The networked video bridge device 200 further comprises a data input module 324. The data input module 324 includes one or more audio/video interface connections for transferring analog and/or digital, audio and/or video data from the image data capture apparatus 104 or other external sources to the networked video bridge device 200. Exemplary audio/video interface connections include RCA, S-Video, and HDMI connections, or any other known audio/video interface connection. Additionally, a microphone input 326 can be included within the networked video bridge device 200. The microphone input 326 communicates with the data input module 324 enabling a user to provide audio data to the networked video bridge device 200.

For example, a user of the networked video bridge device 200 may speak into the microphone input 326 in order to add voice annotations to the image data as the image data is being captured by the data input module 324. Further, the user may review previously captured image data on the networked video bridge device 200 and supplement the previously captured image data with voice annotations. In another example, the user may speak predetermined voice commands into the microphone input 326 in order to control the networked video bridge device 200.

The networked video bridge device 200 may be preprogramed to recognized predefined voice commands. For example, the user may initiate a voice recognition function within the networked video bridge device 200 through a physical interaction with the UI 332, such as by selecting a menu item associated with the voice recognition function. When the user initiates the voice recognition function, the user may then speak a phrase into the microphone input 326. The networked video bridge device 200 compares the spoken phrase to a list of predefined phrases. Each predefined phrase corresponds to a predefined command or action. When the networked video bridge device 200 determines the spoken phrase correlates to a predefined phrase, the networked video bridge device 200 executes the corresponding command or action.

In another example, the user may initiate the voice recognition function by speaking a predefined voice recognition listen phrase. The predefined voice recognition listen phrase corresponds to a predefined command that, when executed, initiates the voice recognition function within the networked video bridge device 200. When the networked video bridge device 200 determines the spoken phrase corresponds to the predefined command, the networked video bridge device 200 executers the predefine command. The voice recognition function then begins receiving audio input from the user. Additionally, the user may manually toggle the microphone input 326 between ON and OFF. For example, the microphone input 326 may include an microphone switch (not shown) that allows a user to turn the microphone input 326 ON and OFF.

The data input module 324 enables other forms of input to be communicated to the networked video bridge device 200. For example, a secondary user interface device 336 can provide inputs to the networked video bridge device 200 via network connections established by the network interface module 316. Such secondary user interface devices 336 can include a wireless keyboard, a SMS capable cellphone, a smartphone, or a laptop computer, for example. Inputs from such secondary user interface devices 336 to the networked video bridge device 200 can be used to augment image data and/or control the function or operation of the networked video bridge device 200.

The control module 304 receives data from the data input module 324. The control module 304 may temporarily store the data within the data storage module 312. Alternatively, the control module 304 may process the data and communicate the data to the network interface module 316. For example, the control module 304 may receive video image data from the data input module 324. The control module 304 may format the received video image data into an appropriate data format prior to communicating the video image data to the network interface module 316. The network interface module 316 may communicate the formatted video image data to the remote image data storage device 112.

The network interface module 316 can also enable the networked video bridge device 200 to send and receive data and commands between the remote image data storage module 328 and/or a secondary user interface device 336. In this regard, the network interface module 316 can enable a network connection or link between the networked video bridge device 200 and one or both of the remote image data storage device 112 and a secondary user interface device 336, such as via Bluetooth, cellular or WiFi, for example.

In another embodiment, the network interface module 316 may enable the networked video bridge device 200 to send and receive data and commands with a network node 348 and a hosted service provider 352. The network node 348 may be a remotely located computing server arranged to send and receive data with the networked video bridge device 200. The hosted service provider 352 may be a third party internet communications provider arranged to communicate instructions, commands, and data with the network node 348. The network node 348 then communicates the instructions, commands, and data to the network interface module 316.

The UI 332 can then enable access to and control of the data, operating features and functions of the networked video bridge device 200 (such as the record or data transmit functions) via either remote image data storage device 112 or the secondary user interface device 336. For example, the networked video bridge device 200 may include a record switch 340. The UI 332 allows a user of the device 200 to toggle ON and OFF the record function of the networked video bridge device 200. Further, the networked video bridge device 200 can sequentially or simultaneously transmit data to the secondary user interface device 336 and the remote image data storage device 112 for additional augmentation and/or viewing.

In another example, the UI 332 allows a user of the networked video bridge device 200 to enable an airplane mode. The user may select the airplane mode by physical interaction with the UI 332. Alternatively, the user may speak a predefined phrase corresponding to a command the enable the airplane mode. When the airplane mode is enabled, the network interface module 316 and the microphone input 326 are disabled. Accordingly, the microphone input 326 stops receiving input and the network interface module 316 stops transmitting and receiving data.

The removable storage media interface module 328 can accommodate any of a variety of known removable storage devices, such as electronic flash memory data storage devices like memory cards or a USB flash drive. It is understood that while only an electronic flash memory and USB flash storage devices are described, the removable storage media interface module 328 may accommodate any removable storage media or devices.

The networked video bridge device 200 can also include an integrated power module 344 that produces and/or supplies electric power for the device. An integrated electric power source can be included in the power module 344, such as a battery, for providing power to the device 200. Alternatively, or in addition to a battery, the power module 344 can include an A/C power adapter that enables the networked video bridge device 200 to receive electrical power from an external A/C power source. Moreover, the A/C power adapter can be operable to charge the battery, if so equipped, in addition to powering the networked video bridge device 200. Still further, the A/C power adapter can alternatively be external to the networked video bridge device 200. The power module 344 can further include a power switch enabling the user to control the powering ON and OFF of the networked video bridge device 200.

Alternatively, a power module 344 can be embedded within another device that is peripheral to the networked video bridge device 200, though still be operable to supply electrical power to the networked video bridge device 200. For example, the image data capture apparatus 104 can incorporate a power module 344 that supplies electric power to both the image data capture apparatus 104 and the networked video bridge device 200. As another alternative, the power module 344 can be incorporated into other peripheral devices, such as a display device, for example.

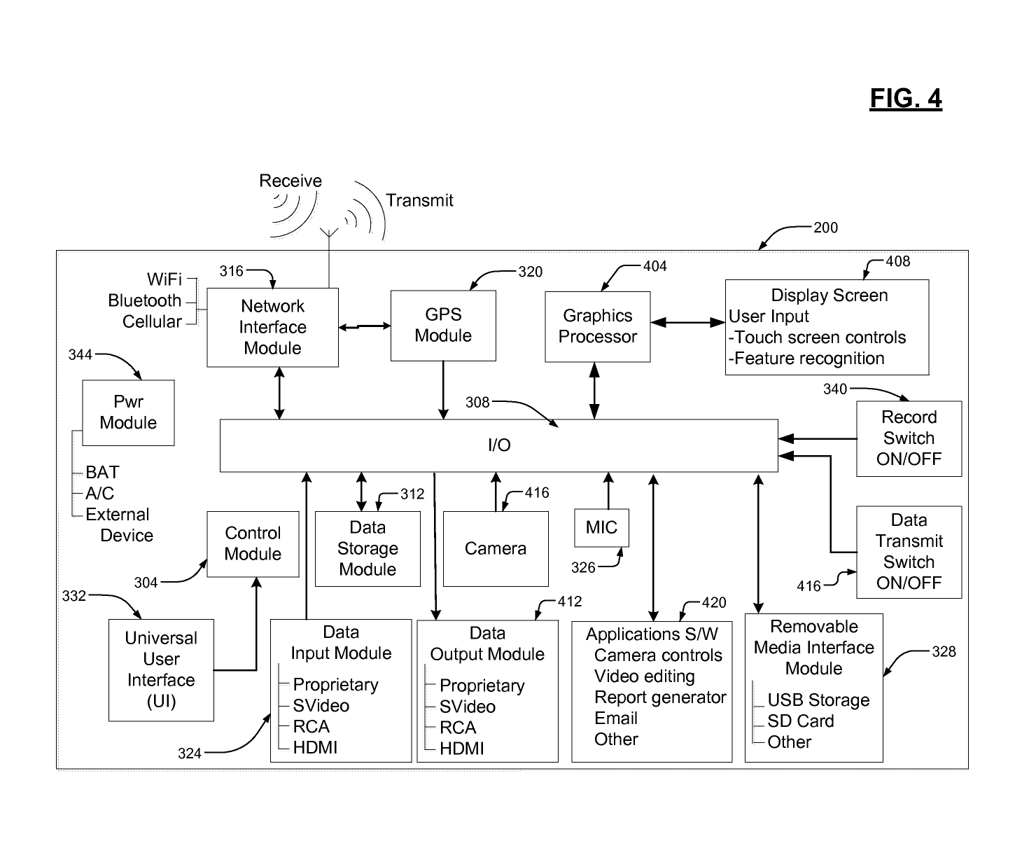

With reference to FIG. 4, an alternative schematic block diagram for the networked video bridge device 200 is illustrated. This configuration of the networked video bridge device 200 further includes the integrated display module 228 (as shown in FIG. 2) for viewing the image data in the networked video bridge device 200. The display module 228 comprises a graphics processor 404 and a display screen 408 featuring touch-screen functionality. The UI 332 can then provide features enabling the user to augment the image data with graphical indicia that can be layered onto or embedded into the images received from the image data capture apparatus 104 as they are viewed on the display screen 228 by the user.

Further, a data output module 412 can be included in the networked video bridge device 200. The data output module 412 enables a direct connection to output the image to an external device, such as the display screen 228 for viewing the image data.

Another feature of this alternative configuration for the networked video bridge device 200 is a data transmit switch 416 for selectively controlling transmitting the image data from the networked video bridge device 200 (e.g., uploading the image data to the remote image data storage device 112). This data transmit switch 416 enables the user to toggle ON and OFF the data transmission from the device 200. This feature can be useful, for example, when network connectivity is less than optimal and/or power for the device 200 is at a premium.

In one embodiment, the configuration of the networked video bridge device 200 shown in FIG. 4 can take the form of a general purpose computer specifically adapted for image data capture and processing. For example, the device 200 can incorporate a direct CCD camera input 416 and include software applications 420 that provide for control of the camera 416 and/or allow the image data to be augmented and further processed in the device 200. For example, the software applications 420 can include or provide for camera control and/or manipulation, video editing, report generation, email, billing, and the like. As discussed above, the UI 332 may allow a user to enable an airplane mode. The airplane mode may further include disabling the camera 416. When the camera 416 is disabled, the camera 416 will not capture image data.

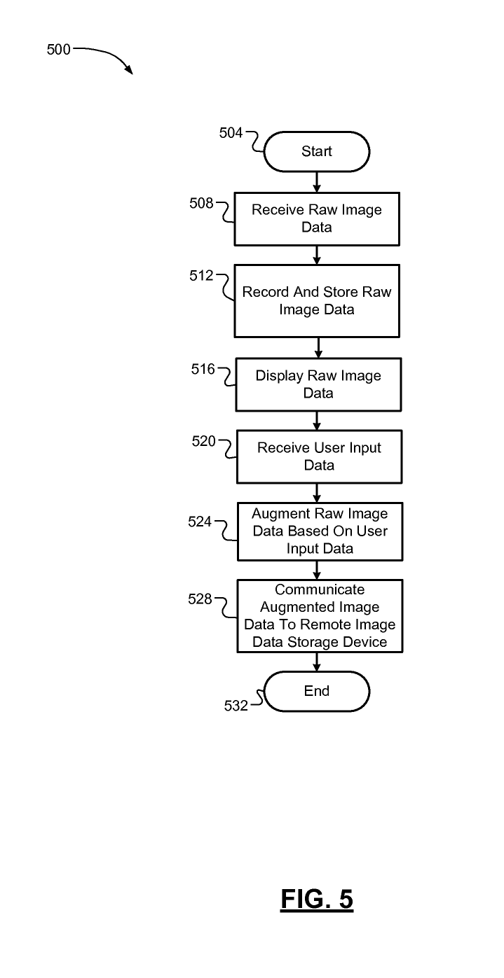

With particular reference to FIG. 5, an image data capture method 500 begins at 504. At 508, the method 500 receives raw image data. At 512, the method 500 records and stores the raw image data. At 516, the method 500 displays the raw image data. At 520, the method 500 receives user input data. At 524, the method 500 augments the raw image data based on the user input data. At 528, the method 500 communicates the augmented image data to a remote image data storage device. The method 500 ends at 532.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A networked video bridge device comprising:
a data input module that receives at least one raw image data stream from a plurality of data sources;
a storage module that records the raw image data and temporarily stores the raw image data;
a display screen that displays the raw image data;
a user interface module that receives user input data from a user of the networked video bridge device; and
a control module that selectively augments the raw image data based on the user input data and that communicates the augmented image data to a remote image data storage device.

2. The networked video bridge device of claim 1 further comprising a global positioning system (GPS) device that determines a location of the networked video bridge device.

3. The networked video bridge device of claim 2 wherein the control module selectively augments the raw image data based on the location.

4. The networked video bridge device of claim 1 further comprising a network interface device that selectively communicates with a plurality of remotely located network systems.

5. The networked video bridge device of claim 4 wherein the network interface device communicates over a data network.

6. The networked video bridge device of claim 1 further comprising a removable storage media module wherein the control module communicates the augmented image data to the removable storage media module.

7. The networked video bridge device of claim 1 further comprising a record ON/OFF switch and a data transmit ON/OFF switch.

8. The networked video bridge device of claim 7 wherein the record ON/OFF switch generates a record signal when the record ON/OFF switch is actuated to a first position.

9. The networked video bridge device of claim 8 wherein the control module selectively instructs the storage module to record the raw image data based on the record signal.

10. The networked video bridge device of claim 7 wherein the data transmit ON/OFF switch generates a transmit signal when the data ON/OFF switch is actuated to a first position.

11. The networked video bridge device of claim 10 wherein the control module selectively instructs the network interface module to transmit the augmented image data based on the transmit signal.

12. A method for capturing a transmitting image data utilizing a networked video bridge device comprising:
receiving at least one raw image data stream from a plurality of data sources;
recording the raw image data and temporarily storing the raw image data;
displaying the raw image data;
receiving user input data from a user of the networked video bridge device; and
selectively augmenting the raw image data based on the user input data and communicating the augmented image data to a remote image data storage device.

13. The method of claim 12 further comprising determining a location of the networked video bridge device.

14. The method of claim 13 further comprising selectively augmenting the raw image data based on the location.

15. The method of claim 12 further comprising selectively communicating with a plurality of remotely located network systems.

16. The method of claim 15 further comprising communicating over a data network.

17. The method of claim 12 further comprising generating a record signal.

18. The method of claim 17 further comprising selectively recording the raw image data based on the record signal.

19. The method of claim 12 further comprising generating a transmit signal.

20. The method of claim 19 further comprising selectively transmitting the augmented image data based on the transmit signal.

21. A networked video bridge device comprising:
a data input module that receives at least one raw image data stream from at least one data source;
a storage module that selectively records the raw image data and temporarily stores the raw image data responsive to a user input;
a user interface module that receives user input data from a user of the networked video bridge device;
a global positioning system (GPS) device that determines a location of the networked video bridge device;
a control module that selectively augments the raw image data based on the user input data and that communicates the augmented image data to a remote image data storage device; and
a network interface device that selectively communicates with a plurality of remotely located network systems.

22. The networked video bridge device of claim 21 wherein the control module selectively augments the raw image data based on the location.
